(19) United States
(12) Patent Application Publication
(10) Pub. No.: US 2025/0387725 A1
(43) Pub. Date: Dec. 25, 2025

(54) SYSTEMS AND METHODS FOR RFID STITCHING OF DATA POINTS TO CREATE A ROUTE AND AGGREGATE AND DISPLAY DATA RELATED THERETO

(71) Applicant: Perceev, Carlsbad, CA (US)

(72) Inventor: Edward Hoffman, Carlsbad, CA (US)

(21) Appl. No.: 19/246,410

(22) Filed: Jun. 23, 2025

Related U.S. Application Data
(60) Provisional application No. 63/662,828, filed on Jun. 21, 2024.
(60) Provisional application No. 63/662,859, filed on Jun. 21, 2024.

(51) Int. Cl. A63K 3/00; G06K 19/07

(52) U.S. Cl. CPC A63K 3/00; G06K 19/0723

(57) ABSTRACT

A method comprising using at least one hardware processor to: selecting race data API's on a race results third party platform; creating an event or race and connecting with a race results third party platform; connecting to the race data associated with the created event or race via the corresponding API's; accessing timer point names via the API's; creating a route using a route creation tool on a map; matching the timing point names/ID's to rank names/ID's and Decimal times with distance markers; placing representations of the distance markers on the map; receiving race result data associated with the timing points; correlating the race result data with the distance markers; and displaying, recording, or both the race result data with respect to the map.

### CROSS-REFERENCE TO RELATED APPLICATIONS

This application claims priority to U.S. Provisional Application No. 63/662,828, entitled, “SYSTEMS AND METHODS FOR RFID STITCHING OF DATA POINTS TO CREATE A ROUTE AND AGGREGATE AND DISPLAY DATA RELATED THERETO”, filed on Jun. 21, 2024, and U.S. Provisional Application No. 63/662,859, entitled, “SYSTEMS AND METHODS FOR A DISPLAY OF DATA RELATED TO EVENT PARTICIPATION” filed Jun. 21, 2025, and is related to U.S. Application No. 63/522,379, filed Jun. 21, 2023 and U.S. Application No. 63/522,380, filed Jun. 21, 2023 all of which are incorporated herein by reference as if set forth in full.

### BACKGROUND

### Field of the Invention

The embodiments described herein are generally directed to aggregating and displaying race date, and more particularly to providing real-time race data and interactivity.

### DESCRIPTION OF THE RELATED ART

Companies exist that provide technology and software that allow race organizers to time the racers and monitor and present race results. For example, the company Race Results provides such technology and software. In a conventional system such as that provide by Race Results (RR), the racers are provided with some form of transponder that can transmit racer information so a racer can be tracked as the racers moves around the course. Often, the transponder is a Radio Frequency Identification (RFID) transponder, which can be active or passive.

An antenna array is then typically placed at various timing points around the course that can pick up signals from the racers' transponders. The antenna array can then be interfaced with a decoder that can decode the signals and provide timing information to a back end system. The back end system can then track the racer's timing and present results.

### SUMMARY

Accordingly, systems, methods, and non-transitory computer-readable media are disclosed to aggregating and displaying race date.

According to one aspect, a method comprising using at least one hardware processor to: selecting race data API's on a race results third party platform; creating an event or race and connecting with the race results third party platform; connecting to the race data associated with the created event or race via the corresponding API's; accessing timer point names via the API's; creating a route using a route creation tool on a map; matching the timing point and ranking names with distance markers; placing representations of the distance markers on the map; receiving race result data associated with the timing point names and ranking name; correlating the race result data with the distance markers; and displaying, recording, or both the race result data with respect to the map.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

Such a conventional system is illustrated in FIG. 3, which shows the transponders 302, antenna arrays 304, and decoders 306. As the racers 308 pass the timing stations, which are defined by the antenna arrays 304, which are interfaced with the decoders 306, information is obtained from their respective transponders 302. Data from the decoders can then be send to the backend system for management and presentation.

But conventional systems such as that provided by RR do allow athletes and fans to access and interact with race results and information during and after a race in a convenient, effective, and entertaining manner.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates race results and timing system that can be implemented within an architecture like the architecture illustrated in FIG. 1, according to an embodiment;

FIG. 4 is a screen shot illustrating a graphical user interface for accessing data using the platform of FIG. 1 on the backend of a race results third party platform, according to an embodiment;

FIG. 5 is a screen shot illustrating a graphical user interface that can be implemented in the platform of FIG. 1 in order to set up a race, according to an embodiment;

FIG. 6 is a screen shot illustrating a graphical user interface that can be implemented in the platform of FIG. 1 in order to insert the url's for the required API's such that platform can then receive required data from a race results third party platform, according to an embodiment;

FIG. 7 is a screen shot illustrating a graphical user interface that provides the timing point names for each timing point on a course that can be retrieved by the platform of FIG. 1 from a race results third party platform, according to an embodiment;

FIG. 8 is a screen shot illustrating a route creation tool of the platform of FIG. 1 that allows a race route to be created in the platform, according to an embodiment;

FIG. 9 is a screen shot illustrating how the frontend the platform of FIG. 1 matches the timing point names to ranking names and the racers decimal time, according to an embodiment;

FIG. 10 is a screen shot illustrating ranking information that can be obtained from the third party race results back end;

FIG. 11 is a screen shot that illustrates how events can be set up from admin panel displayed via an application in platform the platform of FIG. 1 to get live race data via, e.g., Race Result CustomAPI or the like;

FIG. 12 illustrated how the platform of FIG. 1 enables throughput to be scaled easily by adding more instances in, e.g., the AWS ECS for a specified service;

FIG. 13 is a diagram that illustrates how an API module a can be the interface with different devices;

FIG. 14 shows data flow from a mobile client providing GPS data through an API module passing to a core module, storing and processing the GPS data into the persistence database;

FIG. 15 shows data being pulled in via, e.g., Race Result (RR) Simple API with the RR fetcher function in an API module, which then gets passed to core module, which can then process and store the data to database, via GPS processor;

FIG. 16 shows the data flow from, e.g., Race Result Trackbox to API module, where it can be passes to core module, which can process and store the data to the database;

FIG. 17 illustrates the core submodules which comprise services, queues, database schema and entities for backend data processing, e.g., on the platform of FIG. 1;

FIG. 18 illustrates the Crons are used to execute tasks at a designated time;

FIG. 19 illustrates the, in this case Firebase leaderboard format which is saved by the calculate leaderboard cron, which is configured to execute a task of getting live races, and prepare the race by getting the race athletes division, segments, and athletes' information;

FIG. 20 illustrates the, in this case Firebase calculate KOS cron format which is saved by the calculate LOS cron;

FIGS. 21 and 22 illustrate the calculate leaderboard cron and calculate KOS cron processes;

FIG. 23 illustrates a fetch timer cron, which is configured to execute the task that gets data within a live race;

FIG. 24 illustrates the notification trigger cron, which is configured to execute any messages from organizers to be sent to mobile devices; and

FIG. 25 illustrates how races get started and athletes' data get processed and saved; and

FIG. 26 illustrates a process to fetch timer cron executes the task that detects live races, and if found, will fetch athletes' data from, e.g., Race Result Timing Solutions for each timing point, and pipeline the data downstream for processing.

### DETAILED DESCRIPTION

In an embodiment, systems, methods, and non-transitory computer-readable media are disclosed for aggregating and displaying race date.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

### 1.1. Infrastructure

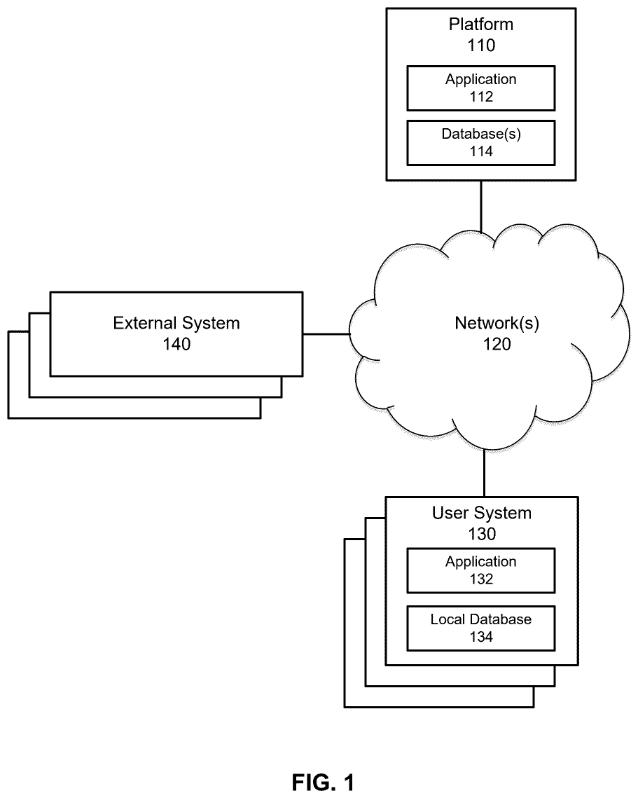

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes, methods, functions, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. It should be understood that platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, MongoDB™, Firebase Database, FireStore Database and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in extensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

### 1.2. Example Processing Device

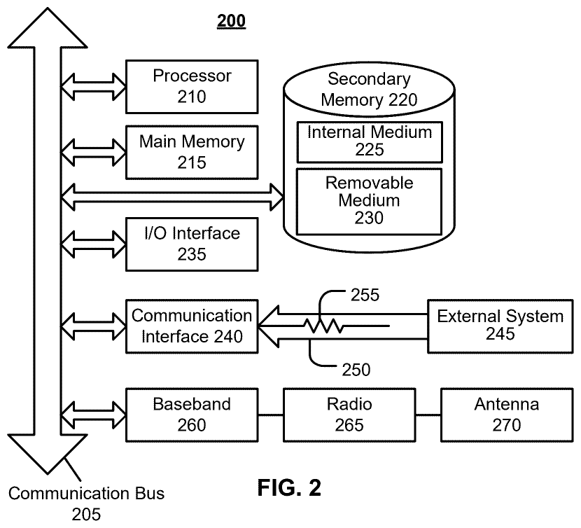

FIG. 2 is a block diagram illustrating an example wired or wireless system 200 that may be used in connection with various embodiments described herein. For example, system 200 may be used as or in conjunction with one or more of the processes, methods, or functions (e.g., to store and/or execute the software) described herein, and may represent components of platform 110, user system(s) 130, external system(s) 140, and/or other processing devices described herein. System 200 can be any processor-enabled device (e.g., server, personal computer, smartphone, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, facial recognition, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, Bluetooth or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various functions of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various functions of the disclosed embodiments.

### 2. Process Overview

Embodiments of processes for aggregating and displaying race date will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### 2.1. RFID Stitching

Platform 110 can be configured to implement a system for aggregating and displaying race date, such as a digital media solution for endurance and other sporting events. A race organizer can use the platform 110 to provide race participants with comprehensive event information, live athlete tracking, official results and in real-time, media broadcasting, games, targeted advertising, performance data, integrated wearable data integration, social engagement, and more. In order to provide the above, platform 110 can incorporate big data analytics, streaming data, portable containers, secure databases, and hyper-aggressive cloud adoption. Moreover, enterprises that experience the most success expanding market share are not those with the most data but those with the most data agility, which is the ability to generate the fastest and most appropriate response to changes in customer demand. As such, platform 110 can be configured for easy scaling across locations and environments providing various aspects of agility: namely: application agility, data agility, and infrastructure agility, which enables resources to be quickly reconfigured and re-allocated according to application needs.

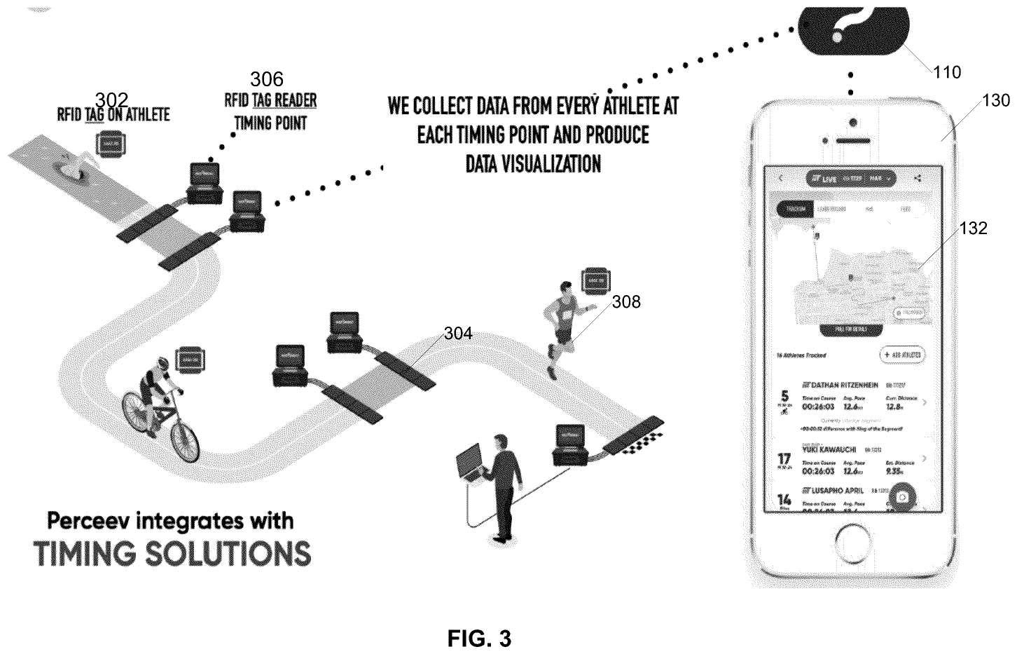

But before describing some of the platform characteristics. A key process for setting up any race is the RFID stitching process that creates the course and allows information to be displayed relative thereto. Returning to FIG. 3, each athlete 308 wears an RFID tag 302 as described above, depending on the type of race, tag 302 can, e.g., found on the back of a participant's bib. The RFID tag 302 has all the relevant information about the participant: age, gender division, bib or race number, email address, etc., As the participant starts the race they pass over a RFID antenna arrays 304 which are interfaced with decoders 306. The decoders 306 can decode the signals received by antenna arrays 304 to extract the data stored on tags 302.

The data can then be sent to, e.g., the RR backend and/or platform 110, where it can then be accessed by platform 110 via Race Result API's as described below. Platform 110 can be configured, in certain embodiments to use a plurality of API(s), e.g., up to 104, to obtain various sets of data from the timing solution providers. Each API(s) sends platform 110 relevant data about each contest and each participant 308 individually or all participants collectively.

Data that platform 110 can be configured to obtain can include contest information, result information, ranking information and athlete information. Platform 110 can also be configured to obtain the timing point (id's)/names, ranking (id's) associated with the timing points and decimal times associated with crossing the timing points, these are associated with location on the course where the timing solutions, i.e., antenna arrays 304 will be placed.

Each of the API(s) provides relevant information about the contest. Platform 110 can then be configured to take all the data from each of the API(s) and stitch it together. The stitched together data can then be presented to, e.g., fans via an application 132 on their user system 130, e.g., their mobile deice.

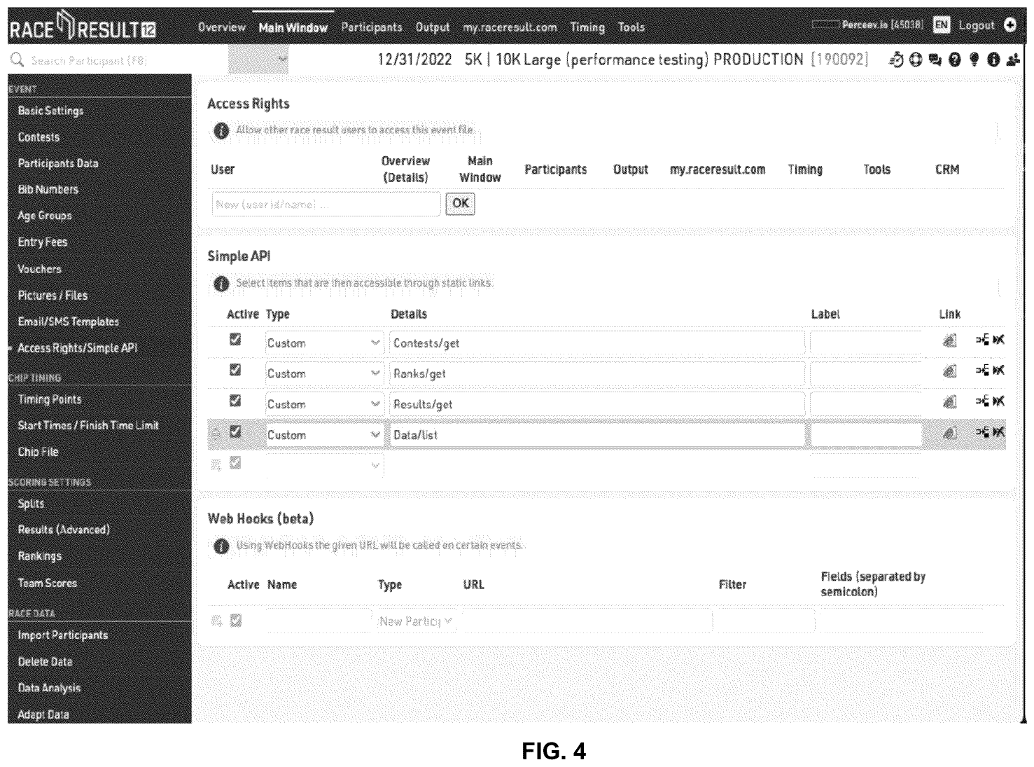

For example, FIG. 4 is a screen shot illustrating a graphical user interface for accessing data on a race results third party platform. The screenshot of FIG. 4 illustrates four API's platform 110 can use to get data from the third party race results platform. In order to receive the API url the user must click on the link icon for each API.

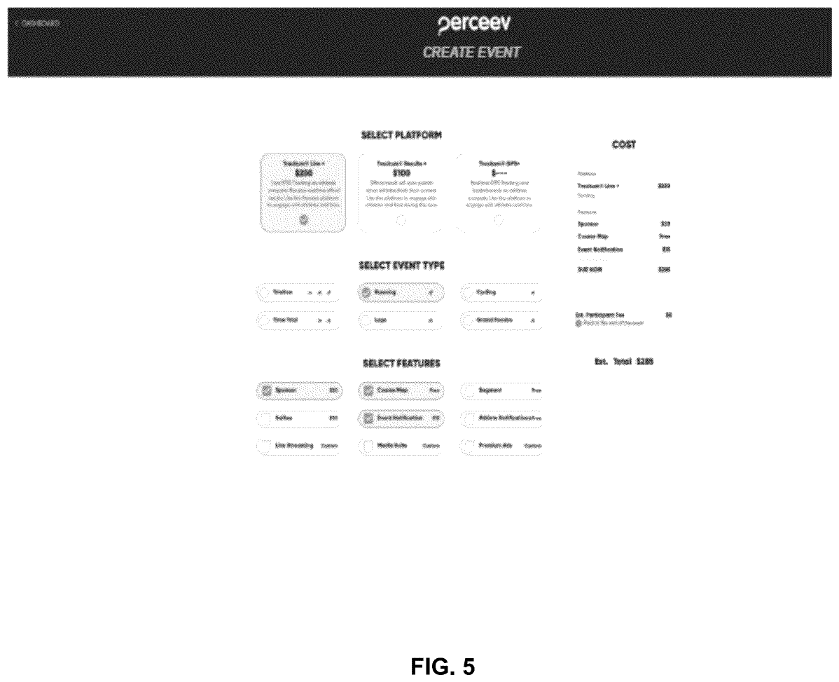

As can be seen in FIG. 5, the race organizer selects the type of package, and therefore data that they are interested in. They can then select the type of race they are organizing, in this example a running race. They can then select the type of features they would like to be available for their race, including in this example and importantly for this description, a course map.

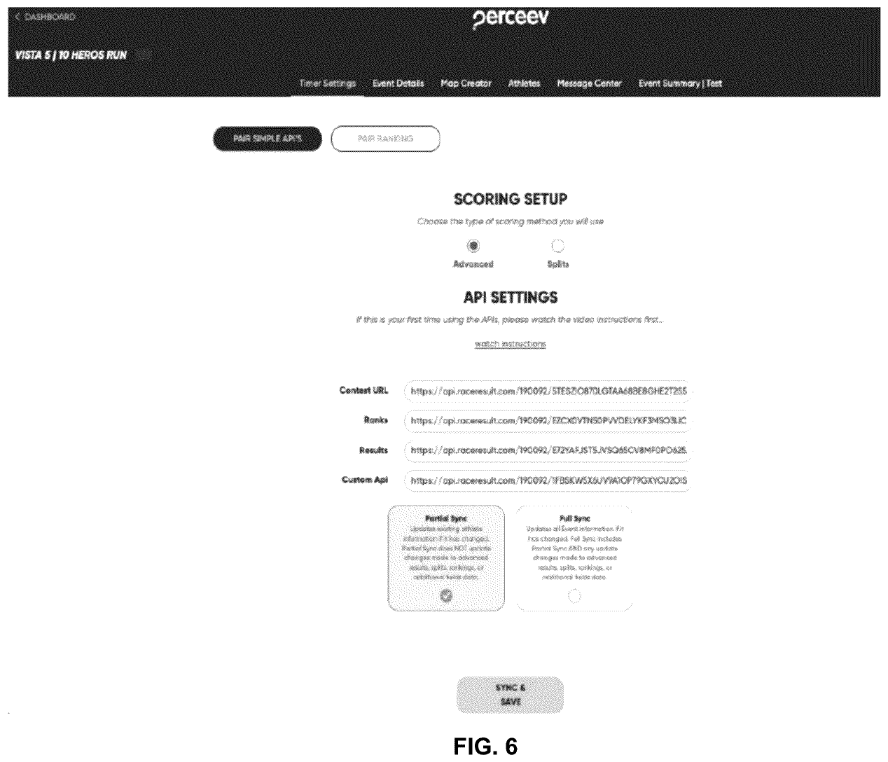

As illustrated in FIG. 6, the url's for the required API's can then be inserted into the platform 110 frontend solution, such that platform 110 can then receive the required data from the third party race result platform e.g., the RR platform.

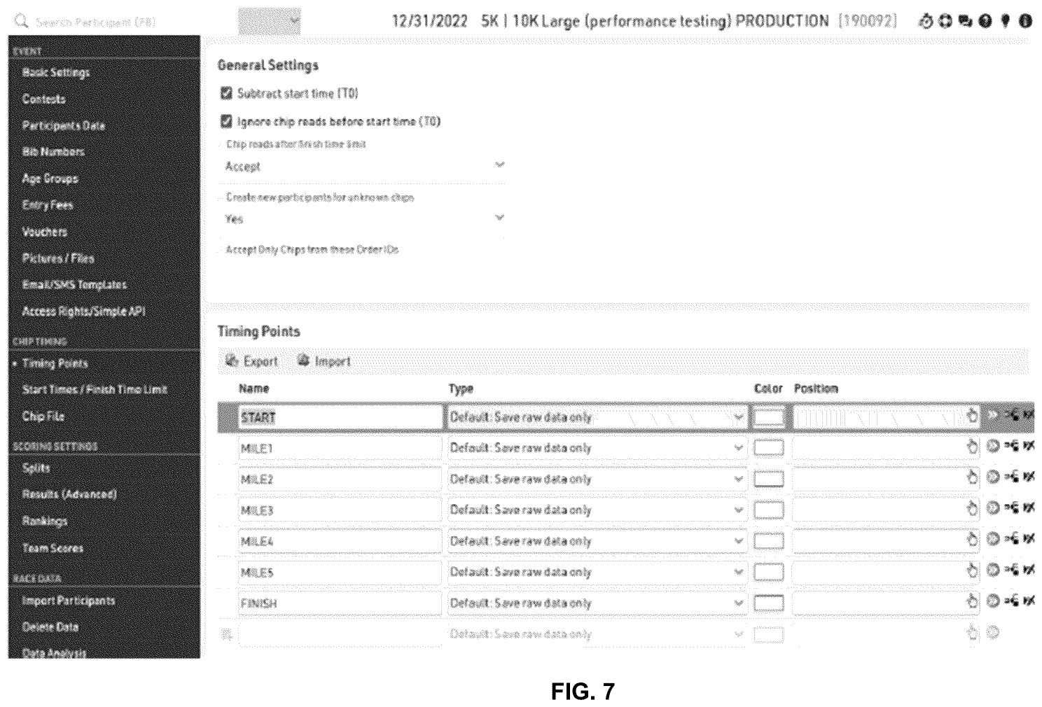

As illustrated in FIG. 7, the timing point names for each timing point on the course can then be retrieved, e.g., from the race result platform via a timing point API(s). The API(s) provide the timing point name and he timing data for each timing point.

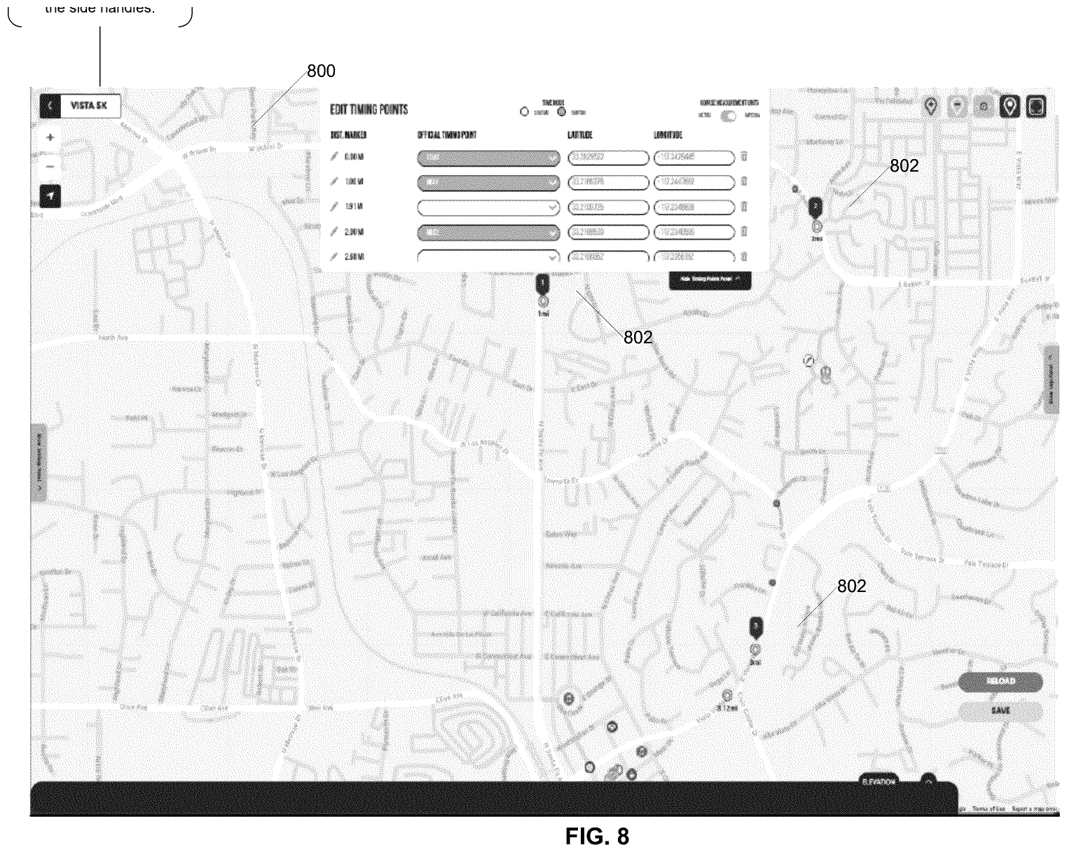

FIG. 8 is a screen shot illustrating the route creation tool of platform 110 that allows the race route to then be created in platform 110. For each contest/race the race timer or organizer must create a contest route for each contest. The tool can be used by the organizer to drop markers 802 on the map 800 that correspond to the timing points. After the organizer create the route on map 800, they create distance markers 802 on the route that correspond to timing points. The distance markers 802 can be named in accordance with the corresponding timing point name provided by the timing solution provider. In other words, if the timing solution provider's timing point name was mile 1, then the route creation tool would make sure the organizer creates a one mile distance marker 802 on the course. As can be seen, the distance markers 802 correlate the latitude and longitude of the distance markers 802 with the distance markers 802, and therefore the timing points. Now the timing points are stitched together with actual distance markers 802 that can be displayed on a map via, e.g., an application 132.

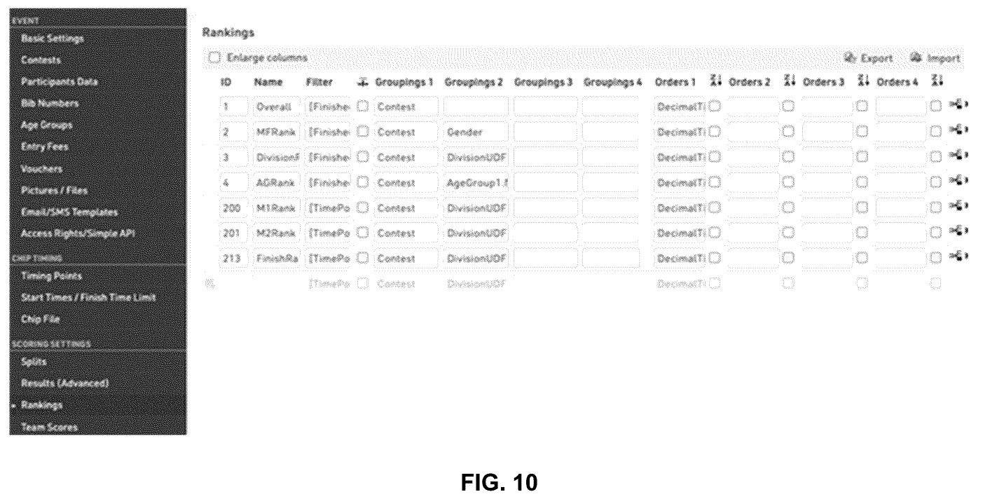

FIG. 10 is a screen shot illustrating ranking information that can be obtained from the third party race results back end.

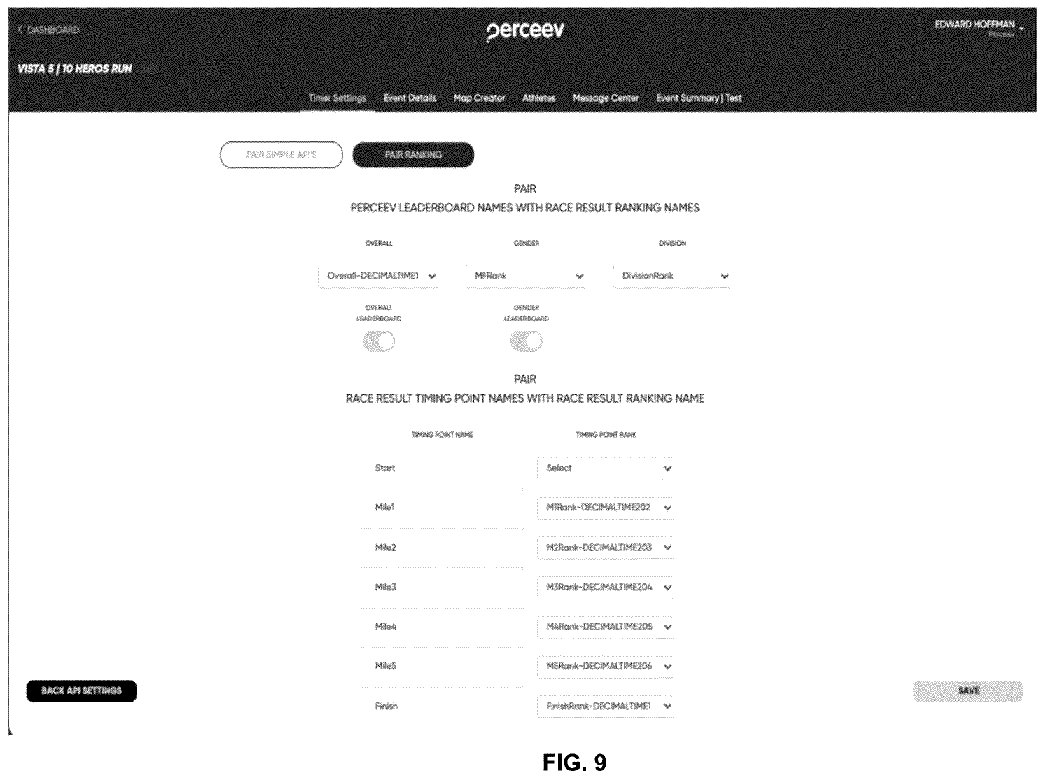

FIG. 9 is a screen shot illustrating how the frontend of platform 110 then matches timing point names/ID's to ranking names/ID's and racers decimal time. For example, for the mile1 timing point, each racer will be ranked as they pass that timing point, and as they pass the timing point they will also have a decimal time. Their rankings are then associated with the timing point, and their decimal time so this data (how long it took them to cross the timing point) can be broadcast and recorded.

### 2.2. Application Agility

Application agility can be implemented in platform 110, in certain embodiments, by using event-driven microservices, e.g., using rabbitMQ cluster as the scalable, fast, and secure data messaging system. Thus, groups of microservices can be coordinated to ensure that data flows smoothly between them and that services are available when needed. The power of this model is its flexibility and scalability, not treating the microservices programs as states but rather as flows. Platform 110 can thus be designed with this concept of distributed processing that enables large volumes of data to be continuously distributed in the event-driven domain.

### 2.3. Data Agility

Traditional systems are often limited in their use of data due to incompatible formats, rigid database limitations and the inability to flexibly combine data from multiple sources. Platform 110 can be configured to address these issues in two ways:

First, a traditional REST API has regid formats and requests different resources from multiple endpoints. The shape and size of the resource is determined by the server. But platform 110 can be configured to use, e.g., a GraphQL API, or the like that simplifies the complexity of requesting different resources from multiple URLs on REST API to just a single request. It transfers the client's workload to get resources from rigid server-defined endpoints to the server and declares what resources are available, and the client asks for what it needs at the time. GraphQL queries provide predictable, stable, and fast data that makes it easier to evolve APIs over time, and most of all it minimizes the overhead of organizing data at the client and server side.

Second, data agility is all about removing the barrier of data usage. The most formidable barriers to data agility aren't technical, but rather cultural. Data is not easily accessed by other departments other than the IT teams. Sensitive data is protected in platform 110, but platform 110 can be configured to provide the ability that administrators can create and share their own analytical models without disturbing production data. Thus, platform 110 can be configured to collect data from mobile networks to enable interactive ad-hoc analysis and the ability to build reports using a variety of rich visualization tools.

### 2.4. Infrastructure Agility

As such, platform 110 provides a turnkey solution for event-organizers to register events with or without timers, and track athletes' activities in real-time with the mobile application 132. The mobile application 132 updates current athletes' geolocation data in real-time to every single user with, e.g., the Google firebase, which can provide a basic, and packed-in many Google features unified platform that can facilitate the development in many ways especially releasing the burden of configuring the server from the developers. All the race real-time data can then be updated in Firebase Real-time database, which is a cloud-hosted database with data in json format, and the data can be synced across all customer clients in real-time that remains available when the application 132 goes offline. Platform 110 adopts this infrastructure agility to solve the bottleneck of accessing resources switching from traditional rigid single SQL database to multiple resources of SQL, NOSQL databases like Redis, MYSQL, MongoDB, Firebase Real-time database, ElasticSearch data store to serve the different needs of applications.

Platform 110 can be configured to use an ad hoc admin panel for organizers to register events or synchronize data via API with the timers that the organizers use as described above. The goal is to simplify the procedure needed to go through many steps of creating an event, and to provide the organizers' needs within seconds. Web and mobile apps 132 are designed with heavy focus on UI/UX that make the design beautiful and lovable. Users will experience a delightful journey of using the apps to track their favorite athletes, viewing their own results, or creating events.

### 2.5. Frontend to Backend Data Flow

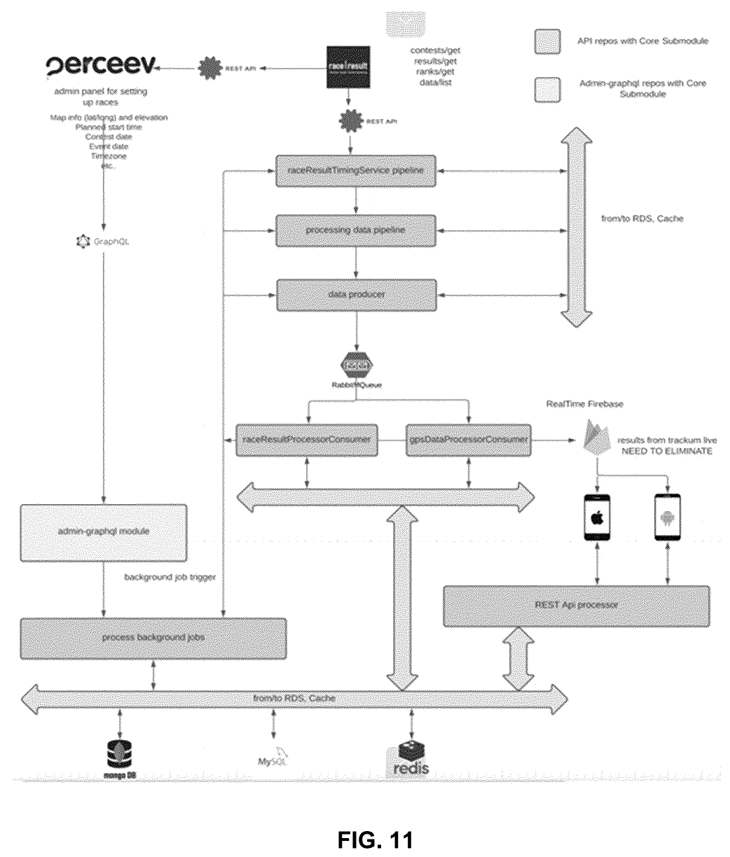

FIG. 11 is a screen shot that illustrates how events, which are, e.g., created in ‘Race Result Timing Solutions’, can be set up from admin panel displayed via an application 112 in platform 110 to get live race data via, e.g., Race Result CustomAPI or the like.

### 2.6. Platform Structure

### 2.6.1. Control Module

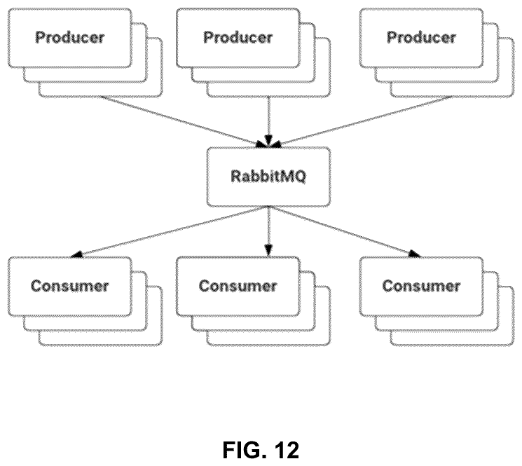

A main component of platform 110 is a core module, which can function as the key to the architecture building block to replicate for each microservice. The core module can be scaled so easily that each microservice can comprise its own core module to deliver the specified service through configuration. This enables the throughput to be scaled easily by adding more instances in, e.g., the AWS ECS for the specified service, such as illustrated in FIG. 12.

Core functions can include:

Cron: cron jobs, which are described in more detail below, are initiated to carry its individual task within specified time-period. They are used as dispatchers of events.

RabbitMQ: RabbitMQ can be used to process high-throughput and background jobs, plus integration and intercommunication between and within applications 112/132. RabbitMQ is used to perform complex routing to consumers and integrate multiple applications and services with non-trivial routing logic. Platform 110 can be configured to use the key, the topic, to produce and to consume various data streams in different topics simultaneously. The records in the system can then be persistent, which makes it possible to reload data when needed, and there is a single shared data no matter how many consumers instead of a queue per consumer on a traditional messaging system. RabbitMQ, for example, has 5 processing queues: 1. GPS_Data—this is the first step of the main trunk of delivering data to, e.g., firebase then it splits to produce two topics; 2. RACERESULT_PROCESSOR—the raceresult_processor consumes this topic to process Race Result, or the like, timing data to, e.g, Firebase. It produces two topics, male and female division data to increase the performance of writing to, e.g., Firebase; 3. MALE_DIVISION_DATA—male_division_data consumes this topic to deliver male athletes timing data to, e.g., Firebase under the race/<race_id>/leaderboard; 4. FEMALE_DIVISION_DATA—female_division_data consumes this topic to deliver female athletes timing data to, e.g., Firebase under the race/<race_id>/leaderboard; and 5. NOTIFICATION—the notification_consumer consumes and delivers organizers' messages to users.

RabbitMQ, for example, can also provide 3 topics that are dormant and will be used at a later date: 1. GPS_PROCESSOR—the gps_processor consumes this topic to process data for gps data to . . . ; 2. VR_ATHLETE_DATA—this is the topic for the VRDataConsumer to consume the virtual race data; and 3. VR_ATHLETE_RACE—this is the topic for the VRRaceConsumer to consume the virtual race in detail.

### 2.6.2. API Module

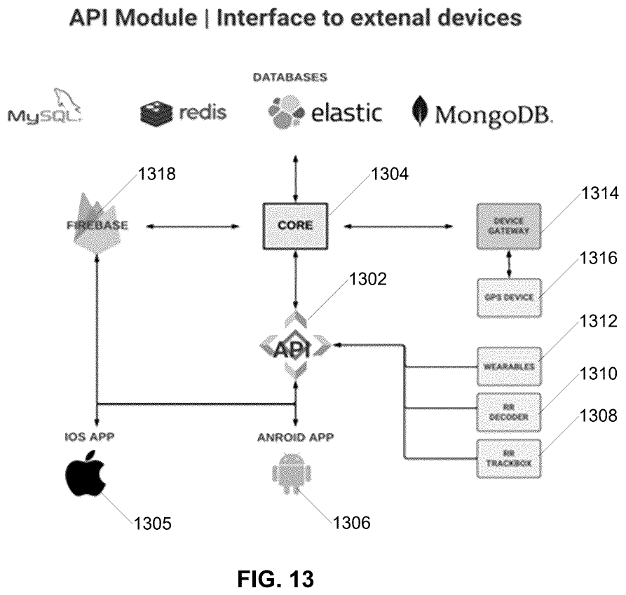

Platform 110 can also comprise an API module 1302 that delivers microservices for different features by adding custom functions extension to the core module 1304 through configuration. FIG. 13 is a diagram that illustrates how the API module 1302 can be the interface with different devices. The API module 1302 can be replicated to serve: 1. Mobile app-ios (1305), android (1306); 2. Race Result timing solution data-simple API, HTTP, TCP/IP (1308 and 1310); 3. Wearables such as smart watches (1312); and other timing solution (not shown). Gateway 1314 can be configured for any external devices giving geolocation through TCP/IP protocol.

Within the API module 1302, administrators can use data from different sources like GPS from Mobile phones or applications (1305, 1306), tracking data from timing solutions like Race Result (1308, 1310) and wearable data from wearable devices such as smart watches 1312. Based on the task, the administrator, or automated routines can process data according to the function. For example, FIG. 14 shows data flow from a mobile client 1402 providing GPS data through API module passing to the core module 1304, storing and processing (modules 1406 and 1410) the GPS data into the persistence database 1404. The data can then be passed, e.g., to Firebase 1318 for use by application 132 on a user system 130 for use and display.

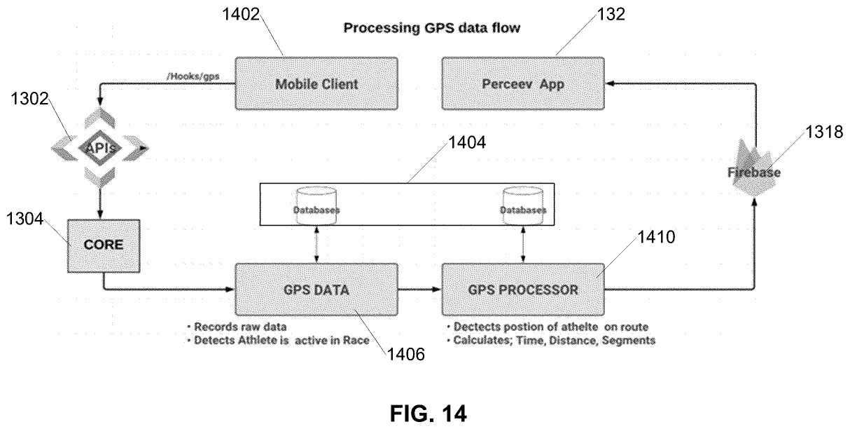

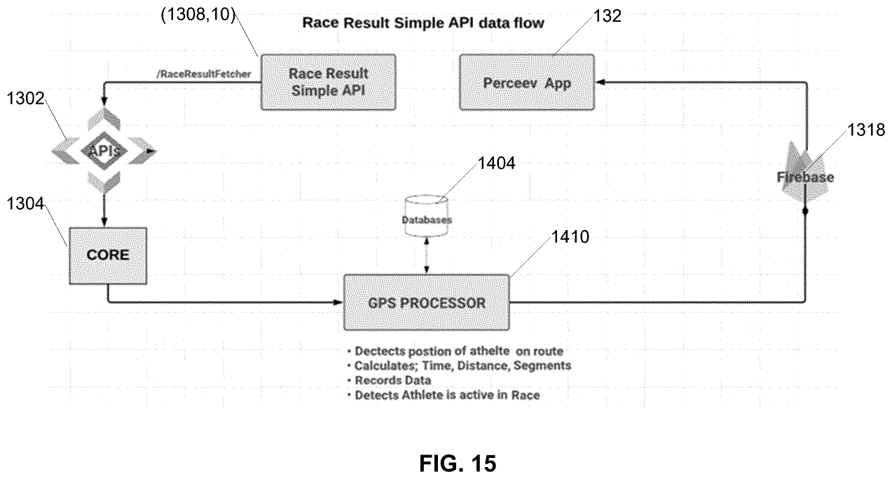

FIG. 15 shows data being pulled in via, e.g., Race Result (RR) Simple API with the RR fetcher function in the API module 1302, which then gets passed to core module 1304, which can then processes and store the data to database 1404, via GPS processor 1410. The data can then be passed to, e.g., Firebase 1318, as the backend service to build mobile apps that provide automatic data synchronization to the real-time database.

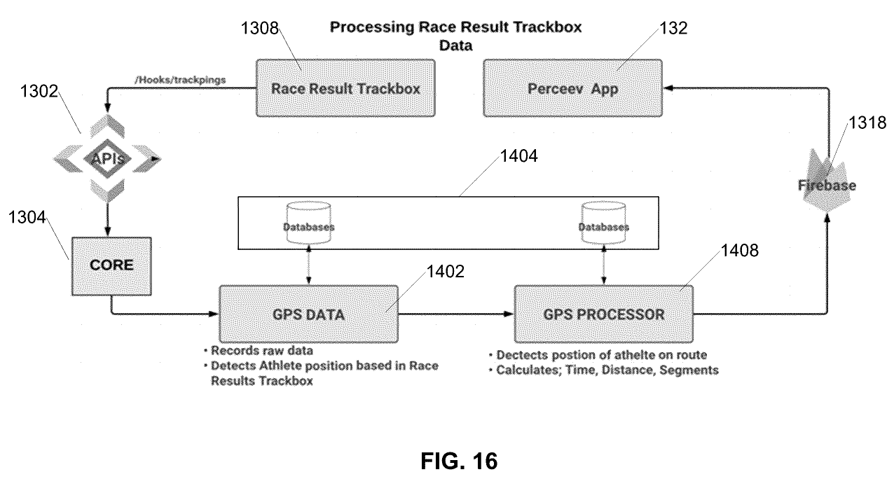

FIG. 16 shows the data flow from, e.g., Race Result Trackbox 1308 to API module 1302, where it can be passes to core module 1304, which can process and store the data to the database 1404 via processors 1402 and 1408. The data can then be passed to Firebase 1318 as the backend service to build Mobile apps that provide automatic data synchronization with the real-time database.

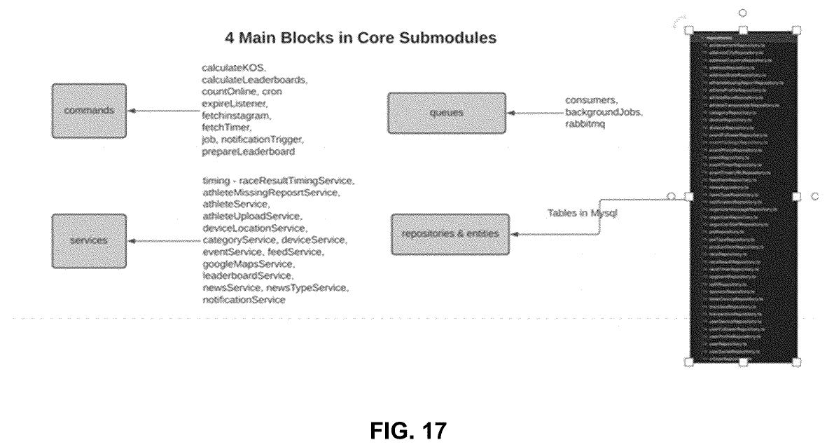

FIG. 17 illustrates the core submodules which comprise services, queues, database schema and entities for backend data processing, e.g., on platform 110. FIG. 17 shows the four main modules within the core submodules. They provide the main functions to get data from, e.g., RESTApi, graphQL, process and format the data to save in mysql, mongo, redis, and Firebase.

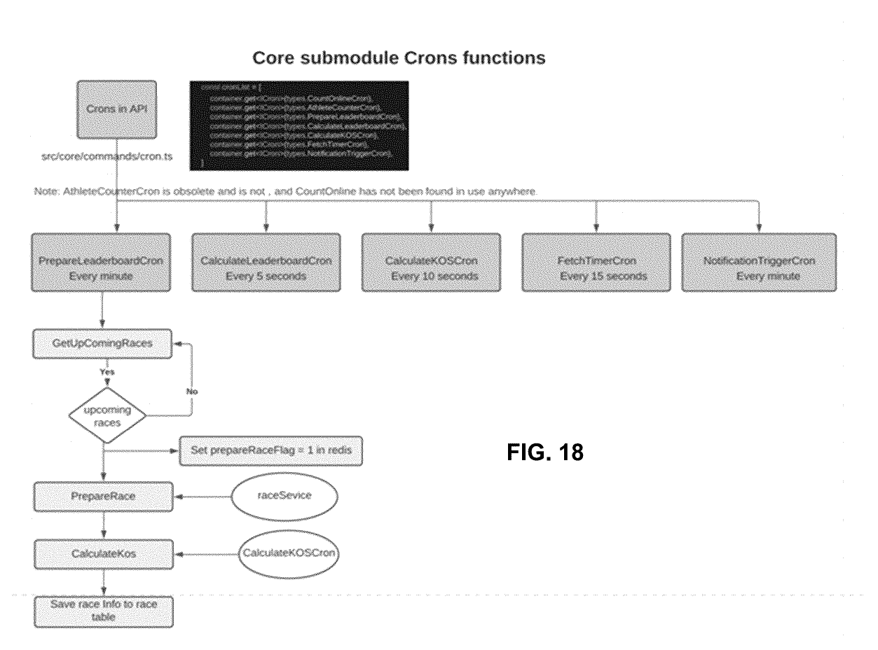

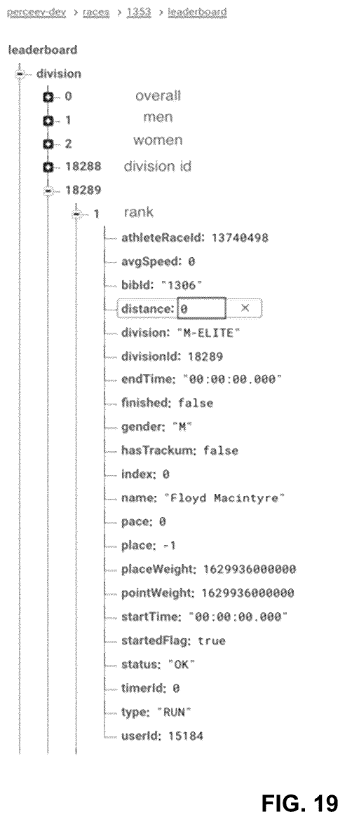

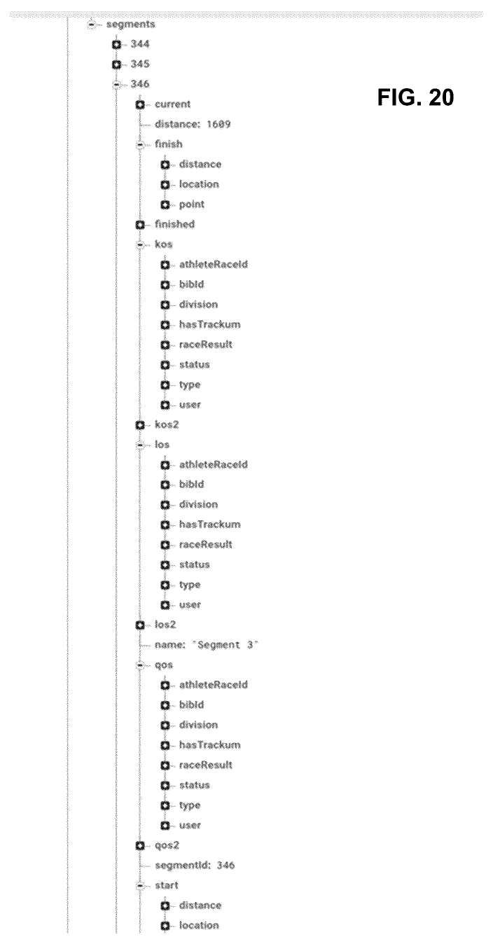

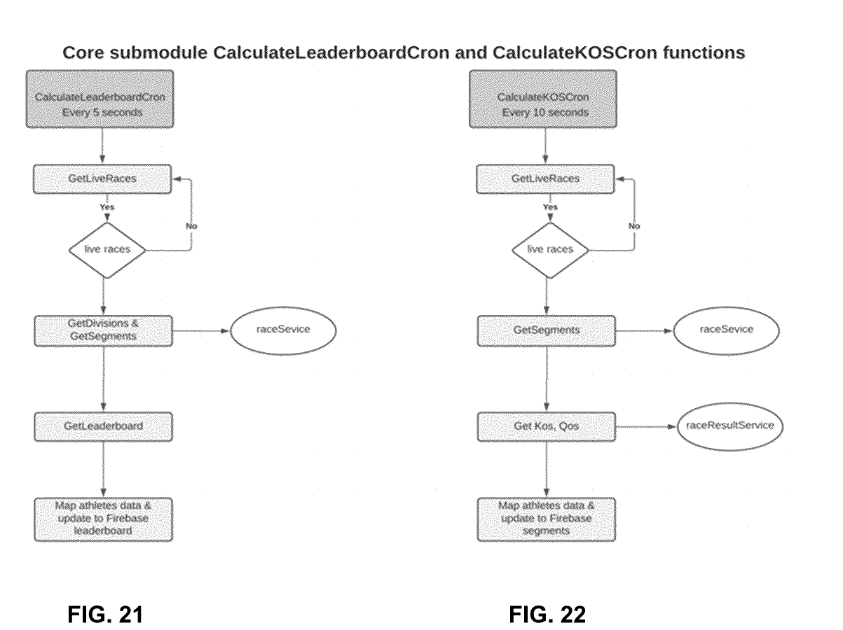

FIG. 18 illustrates the Crons are used to execute tasks at a designated time. For example, FIG. 18 illustrates the prepare leadership board cron process. FIGS. 21 and 22 illustrate the calculate leaderboard cron and calculate KOS cron processes. FIG. 19 illustrates the, in this case Firebase leaderboard format which is saved by the calculate leaderboard cron, which is configured to execute a task of getting live races, and prepare the race by getting the race athletes division, segments, and athletes' information. FIG. 20 illustrates the, in this case Firebase calculate KOS cron format which is saved by the calculate LOS cron.

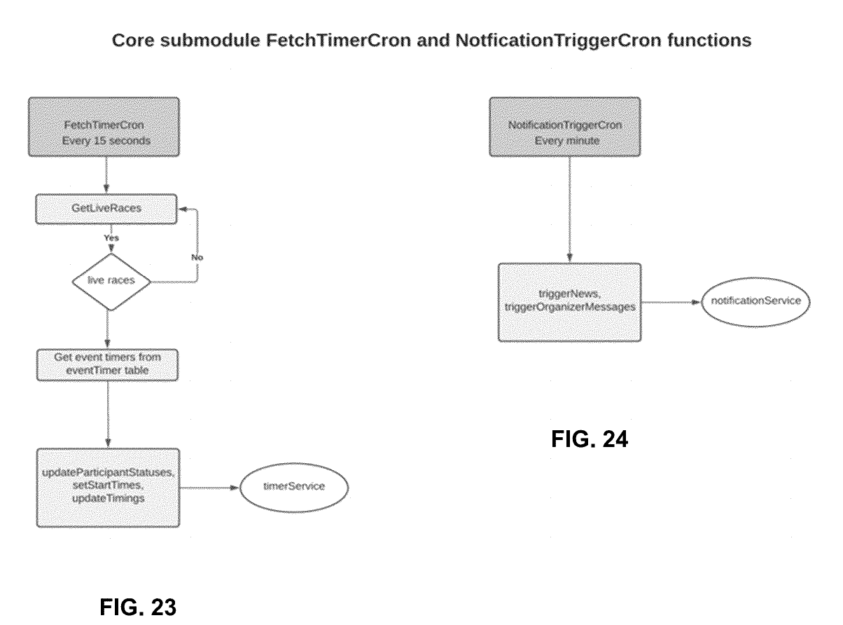

The fetch timer cron, which is configured to execute the task that gets data within a live race is illustrated in FIG. 23. This cron gets all the races that are, e.g., 15 minutes before the race's planned start time, and all athlete's data of the races via custom API 1302 from, e.g., Race Result Timing Solutions.

FIG. 24 illustrates the notification trigger cron, which is configured to execute any messages from organizers to be sent to mobile devices.

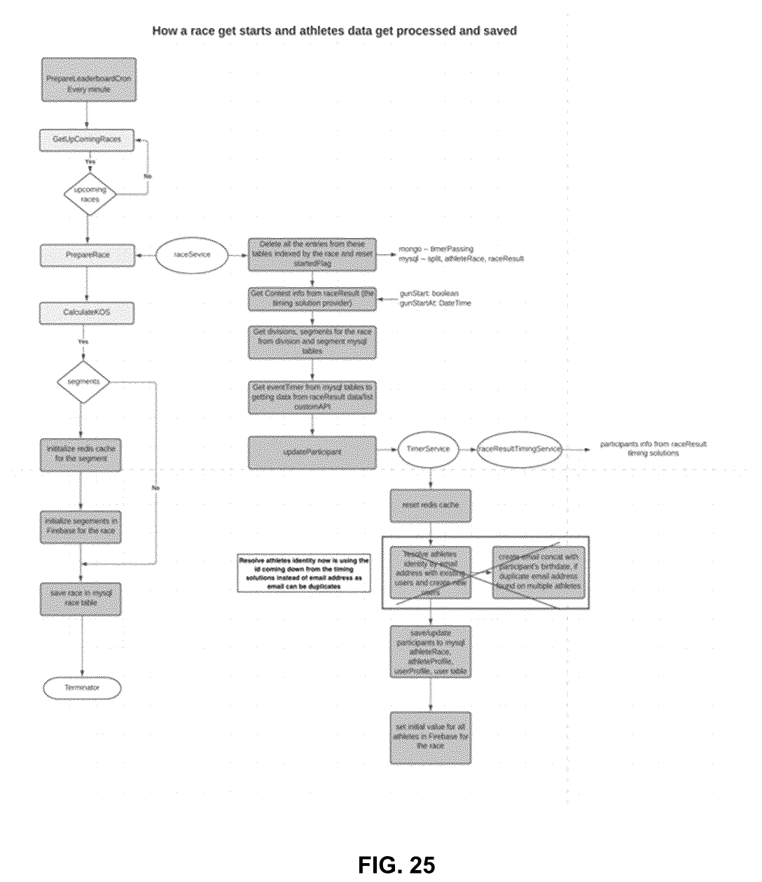

The prepare leaderboard cron is the cron that executes every minute to detect any upcoming races. If upcoming races are detected, then this cron will prepare the race. This is how races get started and athletes' data get processed and saved. FIG. 25 illustrates the workflow for this process.

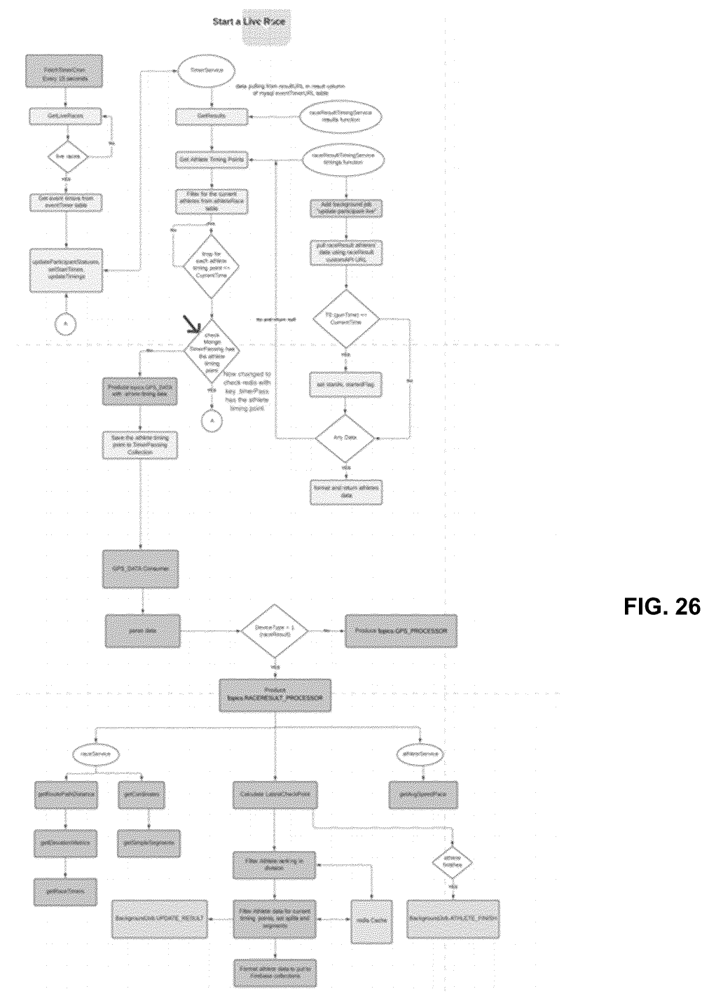

The fetch timer cron executes the task that detects live races, and if found, will fetch athletes' data from, e.g., Race Result Timing Solutions for each timing point, and pipeline the data downstream for processing. Athletes' data are filtered for each timing point and delivered to the race result processor consumer cron to calculate average speed/pace, checkpoints, legs, and sort their division ranks for each timing points, and segments. FIG. 26 illustrates the workflow for this process.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
selecting race data API's on a race results third party platform;
creating an event or race and connecting with a race results third party platform;
connecting to the race data associated with the created event or race via the corresponding API's;
accessing timer point names via the API's;
creating a route using a route creation tool on a map;
matching the timer point names with distance markers;
placing representations of the distance markers on the map;
receiving race result data associated with the timing points, rankings per timing point, and racers decimal time per timing point;
correlating the race result data with the distance markers; and
displaying, recording, or both the race result data with respect to the map.

2. A system comprising:
at least one hardware processor; and
one or more software modules that are configured to, when executed by the at least one hardware processor,
select race data API's on a race results third party platform;
create an event or race and connecting with the race results third party platform;
connect to the race data associated with the created event or race via the corresponding API's;
access timer point names via the API's;
create a route using a route creation tool on a map;
match the timing point names/ID's to rank names/ID's and Decimal times with distance markers;
place representations of the distance markers on the map;
receive race result data associated with the timing points, rankings per timing point, and racers decimal time per timing point;
correlate the race result data with the distance markers; and
display, recording, or both the race result data with respect to the map.

3. A non-transitory computer-readable medium having instructions stored therein, wherein the instructions, when executed by a processor, cause the processor to:
select race data API's on a race results third party platform;
create an event or race and connecting with a race results third party platform;
connect to the race data associated with the created event or race via the corresponding API's;
access timer point names via the API's;
create a route using a route creation tool on a map;
match the timing point names/ID's to with rank names/ID's and Decimal times with distance markers;
place representations of the distance markers on the map;
receive race result data associated with the timing points, rankings per timing point, and racers decimal time per timing point;
correlate the race result data with the distance markers; and
display, recording, or both the race result data with respect to the map.

4. A method comprising using at least one hardware processor to:
receiving race result data associated with the timing points, rankings per timing point, and racers decimal time per timing point for a plurality of participants in an event;
correlating the race result data with the distance markers; and
displaying the race result data with respect to the map;
wherein the display comprises a combination of participant name, identifier, time, pace, distance, rank, and relative performance.

5. The method of claim 4, further comprising:
selecting race data API's on a race results third party platform;
creating an event or race and connecting with a race results third party platform;
connecting to the race data associated with the created event or race via the corresponding API's;
accessing timer point names via the API's;
creating a route using a route creation tool on a map;
matching the timer point names with distance markers;
placing representations of the distance markers on the map;
receiving race result data associated with the timing points, rankings per timing point, and racers decimal time per timing point;
correlating the race result data with the distance markers; and
displaying, recording, or both the race result data with respect to the map.

6. A system comprising:
at least one hardware processor; and
one or more software modules that are configured to, when executed by the at least one hardware processor,
receiving race result data associated with the timing points, rankings per timing point, and racers decimal time per timing point for a plurality of participants in an event;
correlating the race result data with the distance markers; and
displaying the race result data with respect to the map;
wherein the display comprises a combination of participant name, identifier, time, pace, distance, rank, and relative performance.

7. The system of claim 6, wherein the at least one hardware processor; and one or more software modules are further configured to, when executed by the at least one hardware processor,
select race data API's on a race results third party platform;
create an event or race and connecting with the race results third party platform;
connect to the race data associated with the created event or race via the corresponding API's;
access timer point names via the API's;
create a route using a route creation tool on a map;
match the timing point names/ID's to rank names/ID's and Decimal times with distance markers;
place representations of the distance markers on the map;
receive race result data associated with the timing points, rankings per timing point, and racers decimal time per timing point;
correlate the race result data with the distance markers; and
display, recording, or both the race result data with respect to the map.

8. A non-transitory computer-readable medium having instructions stored therein, wherein the instructions, when executed by a processor, cause the processor to:
receiving race result data associated with the timing points, rankings per timing point, and racers decimal time per timing point for a plurality of participants in an event;
correlating the race result data with the distance markers; and
displaying the race result data with respect to the map;
wherein the display comprises a combination of participant name, identifier, time, pace, distance, rank, and relative performance.

9. The non-transitory computer-readable medium having instructions stored therein, wherein the instructions, when executed by a processor, cause the processor to further:
select race data API's on a race results third party platform;
create an event or race and connecting with a race results third party platform;
connect to the race data associated with the created event or race via the corresponding API's;
access timer point names via the API's;
create a route using a route creation tool on a map;
match the timing point names/ID's to with rank names/ID's and Decimal times with distance markers;
place representations of the distance markers on the map;
receive race result data associated with the timing points, rankings per timing point, and racers decimal time per timing point;
correlate the race result data with the distance markers; and
display, recording, or both the race result data with respect to the map.
